(19) United States
(12) Patent Application Publication
(10) Pub. No.: US 2009/0097484 A1
(43) Pub. Date: Apr. 16, 2009

(54) Method And System For Distributing Labels

(75) Inventors: Zhangzhen Jiang, Shenzhen (CN); Jia He, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD.

(21) Appl. No.: 12/098,115

(22) Filed: Apr. 4, 2008

Related U.S. Application Data
(63) Continuation of application No. PCT/CN2007/001814, filed on Jun. 8, 2007.

(30) Foreign Application Priority Data
Jun. 9, 2006 (CN) 200610061050.6

(51) Int. Cl. H04L 12/56

(52) U.S. Cl. 370/390

(57) ABSTRACT

A method, system and apparatus for distributing labels for multicast services. The method deploys a primary controller in the network to manage the label space on a centralized basis; the primary controller distributes a label for the multicast service upon obtaining a request for a label from the multicast service source, which ensures that unicast services and multicast services use different labels, thus solving conflicts between unicast labels and multicast labels and between multicast labels; the primary controller can also query labels for multicast members. The apparatus for distributing labels includes a message interaction unit, a information maintenance unit and a label distribution unit.

### CROSS-REFERENCE TO RELATED APPLICATIONS

This application is a continuation of International Application No. PCT/CN2007/001814, filed Jun. 8, 2007. This application claims the benefit of Chinese Application No. 200610061050.6, filed Jun. 9, 2006. The disclosures of the above applications are incorporated herein by reference.

### FIELD

The present disclosure relates to the multicast technology field, and, to a method, system and apparatus for distributing labels.

### BACKGROUND

The statements in this section merely provide background information related to the present disclosure and may not constitute prior art.

Multicast, which helps to improve the bandwidth utilization and save network resources, is a technology used to transfer messages between a sender and more than one receiver. When a unicast service needs to pass through an operator's network, the usual practice is to put the service in a tunnel for transmission. Therefore, a multicast service may be carried over a point-to-multi-point (P2MP) tunnel. For example, a multicast service may be carried over a Resource ReSerVation Protocol-Traffic Engineering (RSVP-TE) P2MP Label Switched Path (LSP) or over the Label Distribution Protocol (LDP) P2MP LSP. During multicast, one multicast packet is transferred, and is replicated by using multicast bearer technology and sent to all multicast receivers. Based on features of multicast services, the Label Switching Routers (LSRs) of all next hops process the same label, which may result in label conflict.

FIG. 1 shows a case in which unicast labels conflict with multicast labels. Multicast LSP1 indicated by the thick solid lines (LSR1-LSR9-LSR10-LSR4, LSR5, LSR6) distributes the same label, that is, label K, for LSR4, LSR5 and LSR6. As the label distribution process is independent, when unicast LSP2 (that is, LSR2-LSR9-LSR10-LSR5 indicated by the dotted line) is established, label K may also be distributed for LSR5. In this case, a label conflict arises between multicast LSP1 and unicast LSP2. When the services of the two LSPs arrive at LSR5, due to the same label for LSR5, LSR5 is unable to distinguish which LSP the services belong to based on the prior art, thus affecting subsequent forwarding. To solve this problem, the current practice is to distribute another label for unicast LSP2 through signaling such as LDP.

FIG. 2 shows another case in which unicast labels conflict with multicast labels. The thick solid lines indicate multicast LSP1 (that is, LSR1-LSR9-LSP10-LSR4, LSR6), and the dotted lines indicate unicast LSP2 (that is, LSR2-LSR9-LSR10-LSR5). Multicast LSP1 uses label K for LSR4 and LSR6, and unicast LSP2 also distributes label K for LSR5. In this case, suppose LSR5 on LSP2 wishes to join LSP1, which requires that all the next-hop multicast LSRs process the same label, that is, LSR4, LSR6 and LSR5 all use label K. Because label K is already occupied by LSP2, the label conflict described above arises. At present, this problem cannot be solved.

FIG. 3 shows a case in which multicast labels conflict with multicast labels. The thick solid lines indicate multicast LSP1, and the dotted lines indicate multicast LSP2. Because label distribution is an independent process, the same label, that is, label K, is distributed by both LSP1 and LSP2. As a result, a label conflict arises. At present, this problem cannot be solved by the prior art.

When the label conflict shown in FIG. 1 occurs, the solution based on the prior art is to acquire another label by using complicated signaling. This method, however, is unable to solve the problems described in FIG. 2 and FIG. 3. Therefore, it cannot solve label conflicts ultimately.

### SUMMARY

The various embodiments provide a method, system and apparatus for distributing labels so as to effectively avoid the conflicts between multicast services and between multicast services and unicast services.

For this purpose, various embodiments provide the following technical solution:

A method for distributing labels includes:
obtaining, by a primary controller, a request for applying a label from a multicast service source;
querying, by the primary controller, a label information table which the primary controller maintains;
distributing, by the primary controller, a label for a multicast service; and
updating, by the primary controller, the label information table.

A method for distributing labels includes:
obtaining, by a primary controller, a request carrying a multicast service ID for querying a label from a multicast member;
querying, by the primary controller, a label information table which the primary controller maintains based on the multicast service ID;
obtaining, by the primary controller, the label corresponding to the multicast service ID;
distributing, by the primary controller, the label for a multicast service.

A system for distributing labels includes a multicast service source and a multicast member, the system further comprising a primary controller, configured to maintain and manage a label information table, distribute a label upon obtaining a request for applying a label from the multicast service source based on the label information table, and/or query the label information table upon obtaining a request for querying a label from the multicast member.

An apparatus for distributing labels, configured to maintain and manage a label information table, distribute a label from the label information table for a multicast service based on a request for applying a label from a multicast service source, includes:
a message interaction unit, configured to interact with the multicast service source or multicast members in the network;
an information maintenance unit, configured to maintain and manage a label information table; and
a label distribution unit, configured to select an unused label from the label information table when the message interaction unit obtains a request for applying a label from the multicast service source, distribute the unused label to a multicast service, send the distributed label to the message interaction unit, and send a notification for updating the label information table to the information maintenance unit.

Various embodiments n manage the label space on a centralized basis. They maintain and manage label information by using the label information table and ensures that unicast and multicast services use different labels by using the primary controller to distribute labels. In addition, the primary controller may query labels for multicast members, avoiding conflicts between unicast labels and multicast labels and between multicast labels.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 shows a case in which unicast labels conflict with multicast labels in the prior art;

FIG. 2 shows another case in which unicast labels conflict with multicast labels in the prior art;

FIG. 3 shows a case in which multicast labels conflict with multicast labels in the prior art;

FIG. 4 shows a label distribution system according to various embodiments;

FIG. 5 shows various embodiments in which the multicast service source requests a label;

FIG. 6 (a) shows the format of an LDP request for a label according to various embodiments;

FIG. 6 (b) shows the format of forwarding equivalence class (FEC) type-length-value (TLV) in an LDP request for a label according to various embodiments;

FIG. 6 (c) shows the format of optional parameters in an LDP request for a label according to various embodiments;

FIG. 6 (d) shows the format of optional parameters in an LDP request for querying a label according to various embodiments;

FIG. 7 (a) shows the format of a label notification according to various embodiments;

FIG. 7 (b) shows the format of label TLV of a label notification according to various embodiments;

FIG. 8 shows other embodiments in which the multicast service source requests a label;

FIG. 9 shows other embodiments in which a label is released;

FIG. 10 shows the format of an LDP request for releasing a label according to various embodiments;

FIG. 11 shows the format of the label release message according to various embodiments;

FIG. 12 shows other embodiments in which a multicast member queries a label;

FIG. 13 shows other embodiments in which a multicast member queries a label;

FIG. 14 shows other embodiments in which a multicast member queries a label; and

FIG. 15 shows a block diagram of various embodiments.

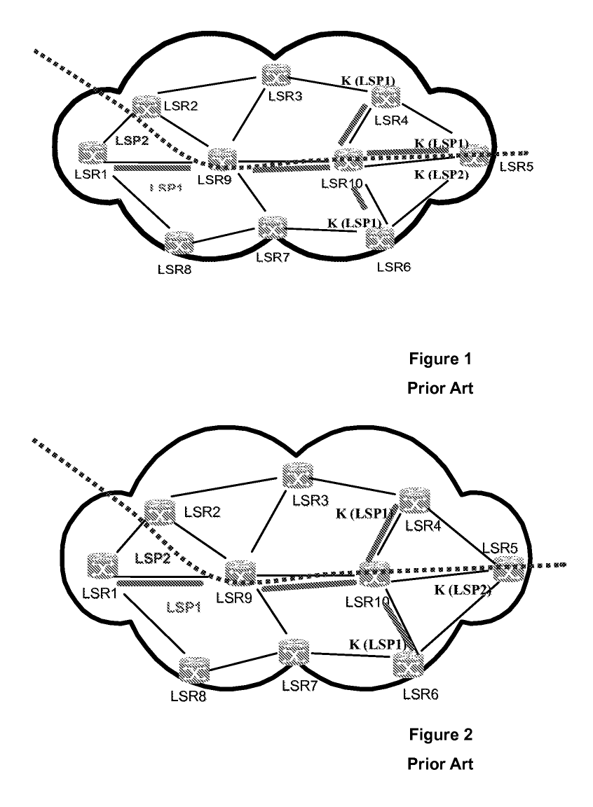

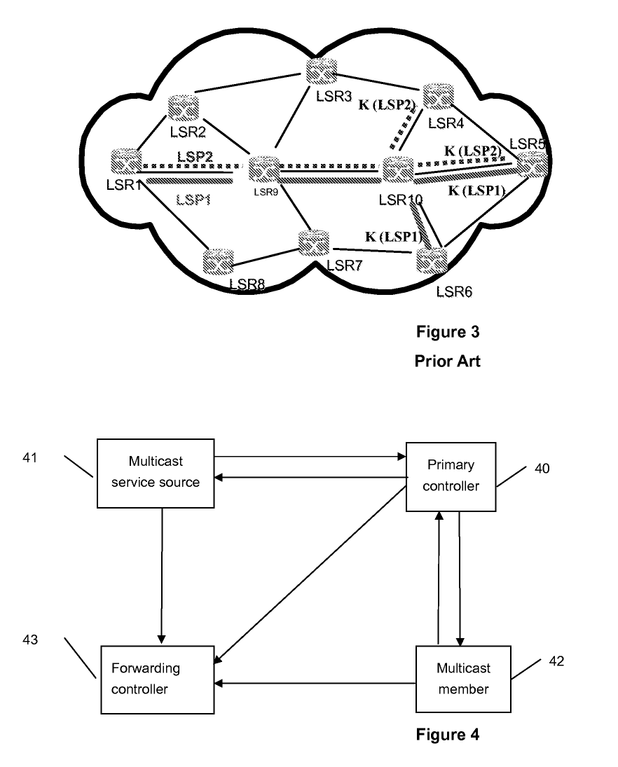

### DETAILED DESCRIPTION

The following description is merely exemplary in nature and is not intended to limit the present disclosure, application, or uses.

Various embodiments manage the label space on a centralized basis by deploying a primary controller in the network, maintain and manage label information by using the label information table. A method is to make the labels in the label information table distributable for unicast and multicast services and ensure that unicast and multicast services use different labels by management; in other words, the label distributed for a unicast service cannot be used by multicast services and the label distributed for a multicast service cannot be used by unicast services. Another method is to use the labels in the label information table for multicast services, but not for unicast services; for example, a range of labels may be specified and the labels in the range may be recorded, managed and maintained by using the label information table. The labels described here refer to global labels, that is, the labels in the whole network.

According to various methods, the label information table may record the usage states of all labels in the whole label space. When Flag is 1, the label is in use; when Flag is 0, the label is not in use. For a label whose Flag is 1, if the Multicast Service ID entry of the label has a value, for example, ID 1 in Table 1, the label is distributed for a multicast service; otherwise, if the Multicast Service ID entry of the label does not have a value, for example, Null in Table 1, the label has been used for a unicast service.

TABLE 1

| Label | Flag | Multicast Service ID |
|---|---|---|
| 001 | 1 | ID 1 |
| 002 | 1 | Null |
| 003 | 0 | Null |
| . . . | . . . | . . . |

According to various methods, the labels in the label information table are used for multicast services only. For example, a range of labels may be specified to differentiate multicast labels from unicast labels. For example, the multicast label space (with labels 100-500) is configured in the primary controller. The labels are in use if their Flag is 1; the labels are not in use if their Flag is 0. Table 2 describes the label information.

TABLE 2

| Label | Flag | Multicast Service ID |
|---|---|---|
| 100 | 1 | ID 1 |
| 101 | 0 | |
| . . . | . . . | . . . |
| 230 | 1 | ID 2 |
| . . . | . . . | . . . |
| 500 | 0 | |

FIG. 4 shows a label distribution system provided according to various embodiments. The system includes multicast service source 41, multicast member 42 and primary controller 40, of which primary controller 40 maintains and manages the label information table, distributes a label for the multicast service of the multicast service source from the label information table upon obtaining a request for a label from the multicast service source, and/or queries a label for multicast member 42 upon obtaining a request for querying a label from the multicast member. The label distribution system also includes forwarding controller 43, configured to obtain labels forwarded by primary controller 40, or multicast service source 41 or multicast member 42. Primary controller 40 may be deployed in the network management system (NMS) or in the main control unit (MCU) of a network element (NE), and forwarding controller 43 is located in an LSR and is configured to control forwarding of multicast services.

Various embodiments also provide a method for distributing labels: The multicast service source requests a label from the primary controller, and the primary controller distributes a label for the multicast service based on the information in the label information table; after the label is distributed, the primary controller sends the label to the forwarding controller; the primary controller may also send the label to the multicast service source before the multicast service source sends the label to the forwarding controller. When a user is to join the multicast group, a query message is sent to the primary controller. If the multicast group exists, the primary controller directly notifies the forwarding controller of the label, or the user notifies the forwarding controller based on the prior distribution mechanism such as downstream distribution after learning the label to be forwarded, or the multicast service source notifies the forwarding controller based on the prior distribution mechanism such as upstream distribution. The primary controller manages labels based on the whole network. In other words, the labels used by multicast services are unique in the whole network, which ensures that no conflict occurs between labels.

The following describes the method based on the system shown in FIG. 4 and the figure in detail.

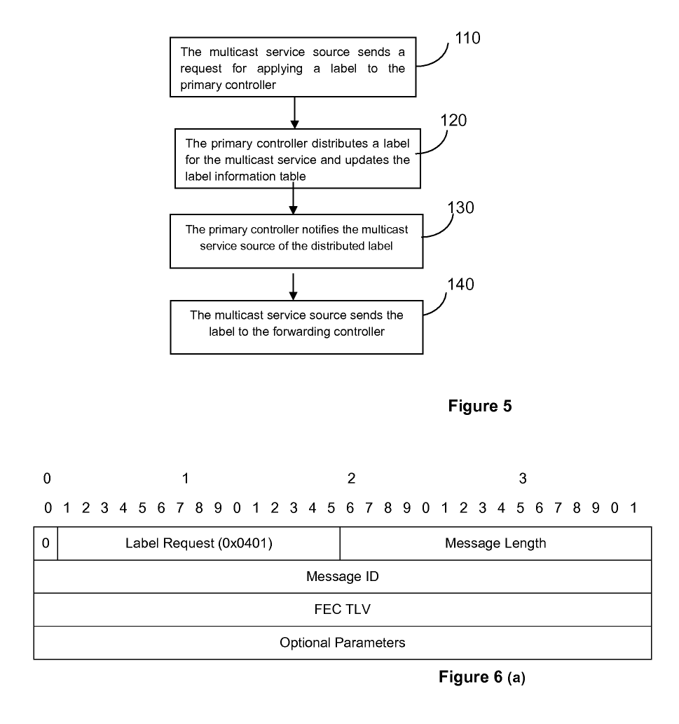

FIG. 5 shows various embodiments in which the multicast service source requests a label. The specific procedure is as follows:

110: The multicast service source sends a request (containing a multicast service ID) for applying a label.

After being online, the multicast service source may register with the primary controller to request a multicast label.

120: Upon obtaining the request, the primary controller distributes a label for the multicast service and updates the label information table. Specifically:

It queries the label information table, selects an unused label and distributes it to the multicast service;

It updates the label information table, that is, adds a multicast service ID to the entry of the label and modifies the usage state flag of the label.

130: The primary controller sends a notification to the multicast service source to notify it of the distributed label.

Besides, the procedure also includes:

140: The multicast service source sends the label to the forwarding controller.

The preceding request for a label may be realized by extending the LDP signaling or other methods. The following describes the LDP signaling as an example in detail.

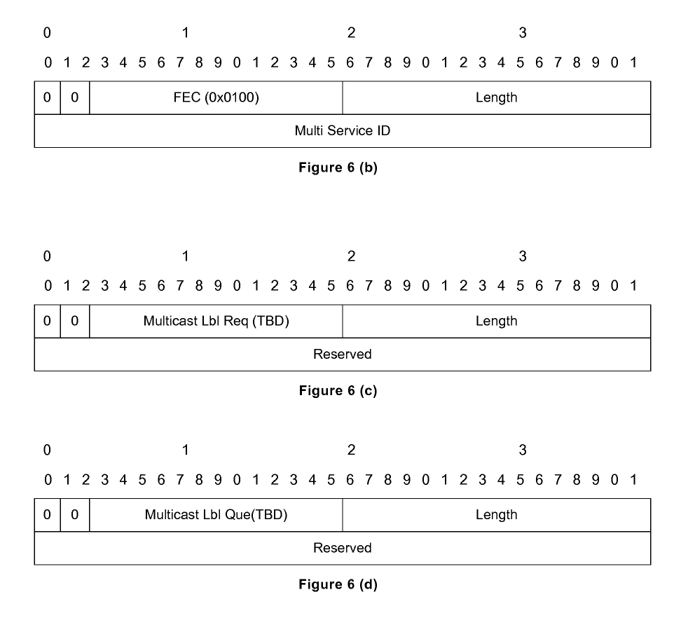

FIG. 6 (a) shows the format of a prior LDP request, in which:

The type of the LDP request is Label Request, which is indicated by 0×0401;

Message Length (16 bits) indicates the length of the message;

Message ID (32 bits) is used to identify the message;

FEC TLV indicates the FEC of the multicast service for which a label is requested;

Optional Parameters: The length of optional parameters is variable, and optional parameters include 0 or more TLVs.

To obtain the preceding request for a label, the invention extends the format of an LDP request shown in FIG. 6 (a) as follows:

(1) The FEC refers to multicast FEC, including a multicast service ID, as shown in FIG. 6 (b).

(2) The label request TLV is added to Optional Parameters, as shown in FIG. 6 (c), indicating a request for a label to the primary controller for the corresponding multicast service.

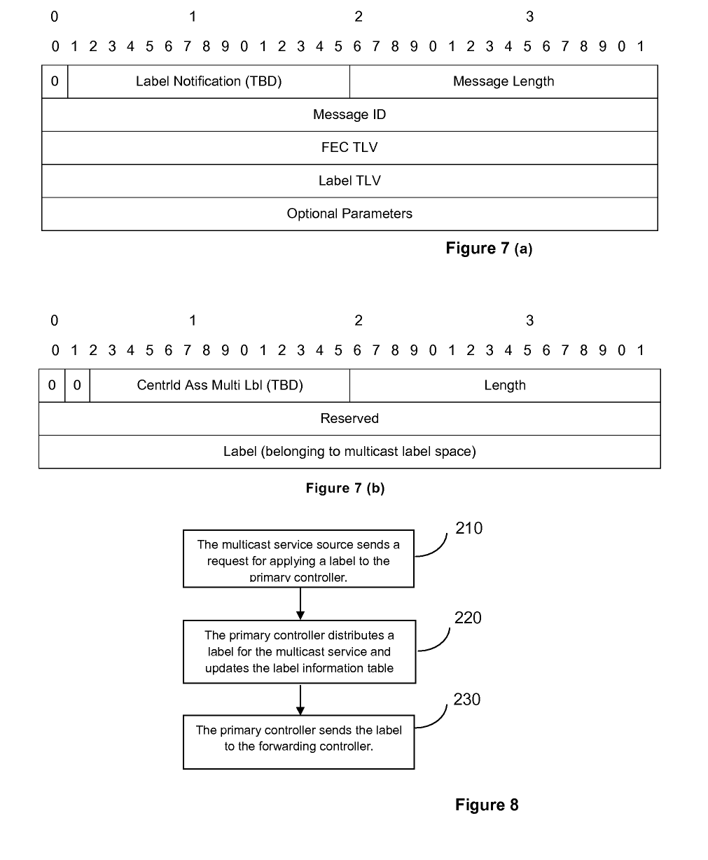

The preceding label notification may adopt the format shown in FIG. 7 (a).

The type of the message is Label Notification and its value is to be determined;

Message Length (16 bits) indicates the length of the message;

Message ID (32 bits) is used to identify the message;

FEC TLV indicates the FEC of the multicast service for which a label is requested, including a multicast service ID, in the same format as the one shown in FIG. 6 (b);

Label TLV indicates a label value distributed on a centralized basis, corresponding to the FEC, as shown in FIG. 7 (b);

Optional Parameters: The length of optional parameters is variable, and optional parameters include 0 or more TLVs, of which Label Request Message ID TLV must be included.

FIG. 8 shows other embodiments in which the multicast service source requests a label. The specific procedure is as follows:

210-220: Same as steps 110-120 in the embodiment shown in FIG. 5.

230: The primary controller sends the label to the forwarding controller.

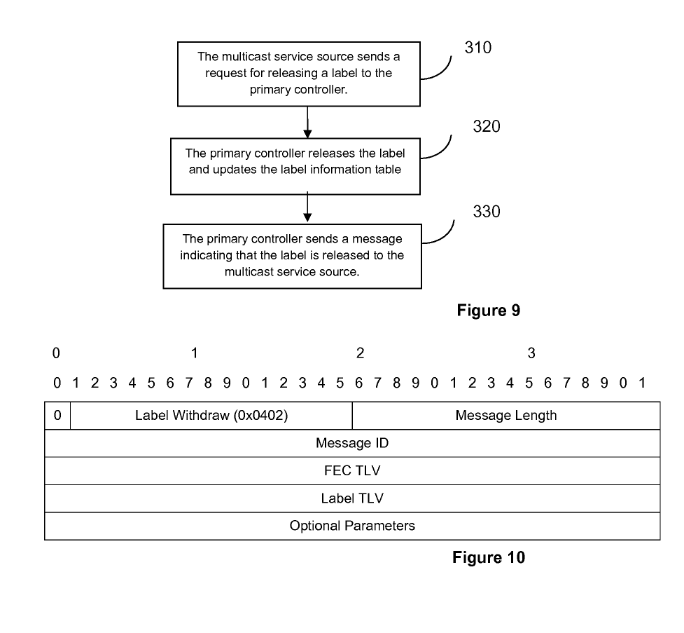

When all members of a multicast service leave the multicast service and the multicast service source expects to remove the multicast service, the procedure for releasing the label is as follows, as shown in FIG. 9:

310: The multicast service source sends a request (containing a multicast service ID) for releasing the label.

320: The primary controller releases the label and updates the label information table.

330: The primary controller sends a message indicating that the label is released to the multicast service source.

The preceding request for releasing a label may be realized by extending the LDP signaling or other methods. The following describes the LDP signaling as an example in detail based on FIG. 10.

FIG. 10 shows the format of an LDP request for releasing a label, in which the type of the LDP request is Label Withdraw, which is indicated by 0×0402, and FEC TLV and Label TLV are the same as those described previously (for details, see FIG. 6 (b) and FIG. 7 (b) ). FIG. 11 shows the format of a label release message, in which the type of the LDP message is Label Release, which is indicated by 0×0403, and FEC TLV and Label TLV are the same as those described previously (for details, see FIG. 6 (b) and Figure 7 (b)).

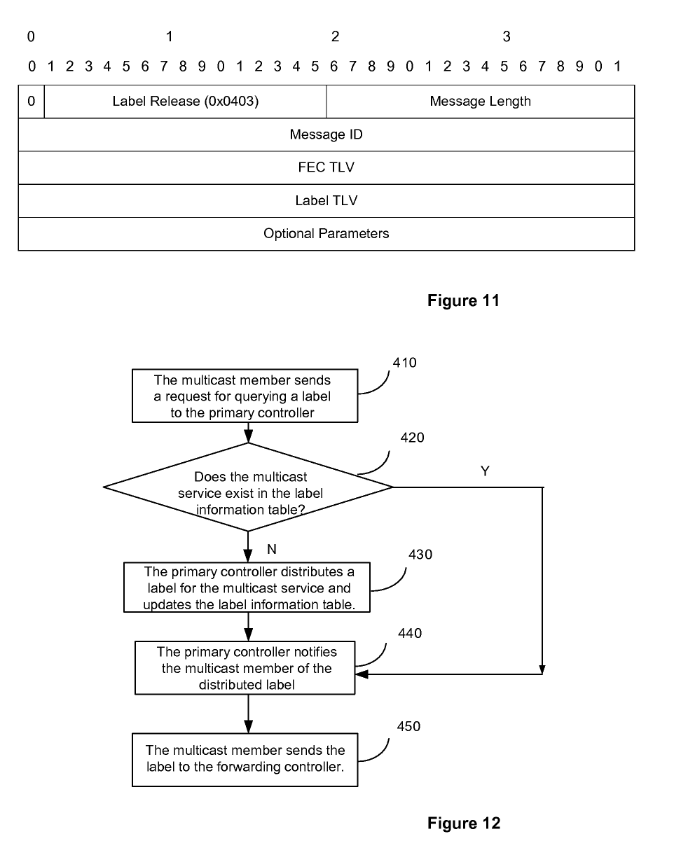

FIG. 12 shows various embodiments in which a multicast member queries a label. The specific procedure is as follows:

410: The multicast member sends a request (containing a multicast service ID) for querying a label to the primary controller.

420: Upon obtaining the request, the primary controller queries the label information table based on the multicast service ID contained in the request.

If there is a corresponding entry in the label information table, the primary controller executes step 440; if there is no corresponding entry in the label information table, it executes step 430.

430: The primary controller distributes a label for the multicast service, updates the label information table and executes step 440.

440: The primary controller sends a notification to the multicast member, notifying it of label distribution, and executes step 450.

450: The multicast member sends the label to the forwarding controller.

In the preceding procedure, the request for querying a label shown in FIG. 6 (a) is similar to the request for a label shown in FIG. 6 (a) in various embodiment of this invention: The FEC TLV also contains a multicast service ID, as shown in FIG. 6 (b); the optional parameters (shown in FIG. 6 (d) indicating the request for querying a label are a little different from those in the request for a label. In addition, the label notification is the same as that described in the various embodiments. See FIG. 7 (a) and FIG. 7 (b).

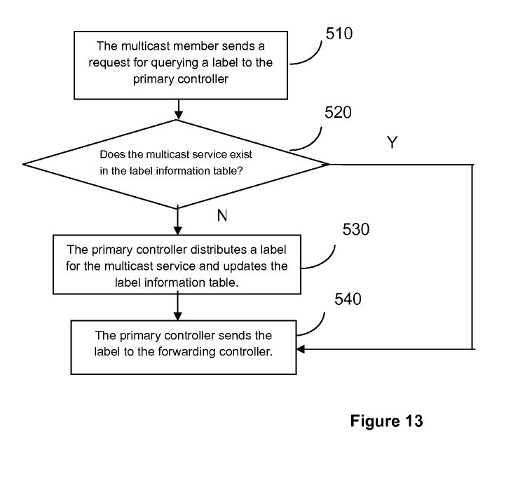

FIG. 13 shows other embodiments in which a multicast member queries a label. The specific procedure is as follows:

510-520: Same as steps 410-420 shown in FIG. 12.

If there is a corresponding entry in the label information table, the primary controller executes step 540; if there is no corresponding entry in the label information table, it executes step 530.

530: The primary controller distributes a label for the multicast service, updates the label information table and executes step 540.

540: The primary controller sends the label to the forwarding controller.

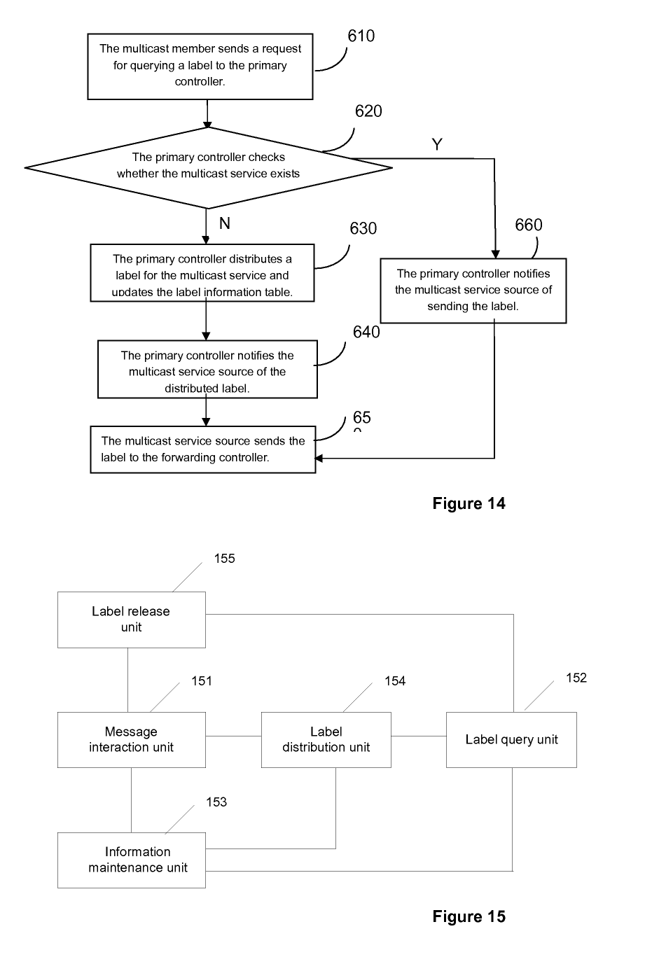

FIG. 14 shows other embodiments in which a multicast member queries a label. The specific procedure is as follows:

610: The multicast member sends a request for querying a label to the primary controller.

620: The primary controller checks whether the multicast service exists. If not, it executes step 630; otherwise, it executes step 650.

630: The primary controller distributes a label for the multicast service and updates the label information table.

640: The primary controller notifies the multicast service source of the distributed label and executes step 660.

650: The primary controller notifies the multicast service source of sending the label.

660: The multicast service source sends the label to the forwarding controller.

In the preceding procedure, if the result of the query performed by the primary controller shows that the multicast service does not exist, and the primary controller is required to distribute a label for the multicast service, the primary controller may also directly send the label to the forwarding controller upon distributing a label for the multicast service.

The mapping between labels and multicast services may also be configured manually on the primary controller. For example, this configuration may be done through the NMS. Specifically, different labels are distributed for different multicast services on the primary controller and the label information table described in Table 3 is maintained in the primary controller, which also supports query of multicast services. If the information of multicast members is known, the primary controller may also directly send the label used by the multicast service to the forwarding controller.

TABLE 3

| Multicast Service ID | Label |
|---|---|
| ID 1 | 100 |
| ID 2 | 101 |
| . . . | . . . |
| ID 501 | 500 |

To effectively avoid label conflicts during distribution of labels for multicast services, various embodiments also provide an apparatus for distributing labels in multicast services. The apparatus is configured to maintain the label information table and distribute labels for multicast services as required by the multicast service source. The apparatus provided in various embodiments may serve as the primary controller shown in FIG. 4.

As shown in FIG. 15, the apparatus provided in various embodiments includes message interaction unit 151, information maintenance unit 153 and label distribution unit 154. Message interaction unit 151 interacts with the multicast service source or multicast members in the network; information maintenance unit 153 is configured to maintain and manage the label information table; label distribution unit 154 is configured to select an unused label from the label information table and distribute it to the multicast service upon obtaining a request for a label from the multicast service source; it also delivers the distributed label to message interaction unit 151 for sending and notifies information maintenance unit 153 of updating the label information table.

To enable new multicast members to obtain the label of a multicast service, label query unit 152 is also deployed in the apparatus. It is configured to query the label information table when message interaction unit 151 obtains a request for querying a label from a multicast member. If the label corresponding to the multicast service ID in the request is found, label query unit 152 delivers the label to message interaction unit 151 for sending; if the label is not found, label query unit 152 notifies label distribution unit 154 of distributing a label for the multicast service.

The apparatus provided in the various embodiments also includes label release unit 155, which is configured to release the label corresponding to the multicast service ID and notify information maintenance unit 153 of updating the label information table when message interaction unit 151 obtains a request for releasing a label from the multicast service source.

Although the teachings have been described through various exemplary embodiments, the teachings are not limited to such embodiments. It is apparent that those skilled in the art can make various modifications and variations without departing from the scope of the teachings. The disclosure is intended to cover the modifications and variations provided that they fall in the scope of protection defined by the following claims or their equivalents.

What is claimed is:

1. A method for distributing labels, comprising:
obtaining, by a primary controller, a request for applying a label from a multicast service source;
querying, by the primary controller, a label information table which the primary controller maintains;
distributing, by the primary controller, a label for a multicast service; and
updating, by the primary controller, the label information table.

2. The method of claim 1, further comprising:
sending, by the primary controller, a notification carrying the label to the multicast service source; and
sending, by the multicast service source, the label to a forwarding controller.

3. The method of claim 1, further comprising sending, the primary controller, the label to a forwarding controller.

4. The method of claim 1, further comprising obtaining, by the primary controller, the label of the multicast service when a multicast member joins the multicast service.

5. The method of claim 4, wherein the procedure for obtaining the label of the multicast service by the primary controller comprises:
sending, the multicast member, a request carrying a multicast service ID for querying the label to the primary controller;
querying, by the primary controller, the label information table based on the multicast service ID upon obtaining the request; and
obtaining, by the primary controller, the label corresponding to the multicast service ID.

6. The method of claim 5, further comprising sending, by the primary controller, the label to the forwarding controller.

7. The method of claim 5, further comprising:
sending, by the primary controller, a notification carrying the label to the multicast member; and
sending, by the multicast member, the label to the forwarding controller.

8. The method of claim 5, further comprising sending, by the multicast service source, the label to the forwarding controller upon obtaining a notification from the primary controller.

9. The method of claim 1, further comprising:
obtaining, by the primary controller, a request carrying a multicast service ID for releasing the label from the multicast service source;
releasing, by the primary controller, the label corresponding to the multicast service ID;
updating, by the primary controller, the label information table; and
sending, by the primary controller, a message indicating that the label is released to the multicast service source.

10. The method of claim 1, wherein the label information table comprises labels, flags indicating usage states of the labels and multicast service IDs, and the flag is used to differentiate used labels from unused labels.

11. The method of claim 1, wherein distributing, by the primary controller, different labels for different multicast services in the whole network.

12. A method for distributing labels, comprising:
obtaining, by a primary controller, a request carrying a multicast service ID for querying a label from a multicast member;
querying, by the primary controller, a label information table which the primary controller maintains based on the multicast service ID;
obtaining, by the primary controller, the label corresponding to the multicast service ID;
distributing, by the primary controller, the label for a multicast service.

13. The method of claim 12, wherein the procedure for distributing the label for the multicast service by the primary controller comprises:
sending, by the primary controller, a notification carrying the label to the multicast member; and
sending, by the multicast member, the label to a forwarding controller.

14. The method of claim 12, wherein the procedure for distributing the label for the multicast service by the primary controller comprises sending, by the primary controller, the label to a forwarding controller.

15. The method of claim 12, wherein the procedure for distributing the label for the multicast service by the primary controller comprises:
sending, by the primary controller, a notification carrying the label to a multicast service source; and
sending, by the multicast service source, the label to a forwarding controller.

16. The method of claim 12, wherein the procedure for querying the label information table and obtaining the label corresponding to the multicast service ID by the primary controller comprises:
distributing, by the primary controller a label for the multicast service if the multicast service ID does not exist in the label information table; and
updating, by the primary controller, the label information table.

17. The method of claim 12, wherein the label information table comprises labels and multicast service IDs.

18. A system for distributing labels, comprising a multicast service source and a multicast member, wherein the system further comprises a primary controller, configured to maintain and manage a label information table, and distribute a label upon obtaining a request for applying a label from the multicast service source based on the label information table.

19. The system of claim 18, further comprising the primary controller, configured to query the label information table upon obtaining a request for querying a label from the multicast member.

20. The system of claim 19, further comprising a forwarding controller, configured to obtain a label sent by least one of the primary controller, the multicast service source and the multicast member.

21. A system for distributing labels, comprising a multicast service source and a multicast member, wherein the system further comprises a primary controller, configured to maintain and manage a label information table, and query the label information table upon obtaining a request for querying a label from the multicast member.

22. An apparatus for distributing labels, comprising:
a message interaction unit, configured to obtain a request for applying a label from a multicast service source;
an information maintenance unit, configured to maintain and manage a label information table; and
a label distribution unit, configured to select an unused label from the label information table, distribute the unused label to a multicast service, send the distributed label to the message interaction unit, and send a notification for updating the label information table to the information maintenance unit.

23. The apparatus of claim 22, further comprising:
the message interaction unit, configured to obtain a request carrying a multicast service ID for querying a label from a multicast member; and
a label query unit, configured to query the label information table, send a label to the message interaction unit if the label corresponding to the multicast service ID is found, and send a notification for distributing a new label to the label distribution unit if a label is not found.

24. The apparatus of claim 22, further comprising:
the message interaction unit, configured to obtain a request carrying a multicast service ID for releasing a label from the multicast service source; and
a label release unit, configured to release a label corresponding to the multicast service ID, and send a notification for updating the label information table to the information maintenance unit.

25. An apparatus for distributing labels, comprising:
a message interaction unit, configured to obtain a request carrying a multicast service ID for querying a label from a multicast member;
an information maintenance unit, configured to maintain and manage a label information table;
a label distribution unit, configured to select an unused label from the label information table, distribute the unused label to a multicast service, send the distributed label to the message interaction unit, and send a notification for updating the label information table to the information maintenance unit; and
a label query unit, configured to query the label information table, send a label to the message interaction unit if the label corresponding to the multicast service ID is found, and send a notification for distributing a new label to the label distribution unit if a label is not found.
